(19) United States
(12) Patent Application Publication
(10) Pub. No.: US 2018/0050683 A1
(43) Pub. Date: Feb. 22, 2018

(54) METHOD OF CONTROLLING ENGINE DRIVING FORCE DURING OPERATION OF TRACTION CONTROL SYSTEM OF HYBRID VEHICLE

(71) Applicants: Hyundai Motor Company, Seoul (KR); Kia Motors Corporation, Seoul (KR)

(72) Inventors: Teh Hwan Cho, Anseong (KR); Sang Joon Kim, Seoul (KR); Gwang Il Du, Incheon (KR); Ji Hoon Kang, Seoul (KR); Seong Ik Park, Seoul (KR)

(21) Appl. No.: 15/368,507

(22) Filed: Dec. 2, 2016

(30) Foreign Application Priority Data
Aug. 22, 2016 (KR) 10-2016-0105973

(51) Int. Cl. B60W 20/15; B60K 6/22

(52) U.S. Cl. CPC B60W 20/15; B60K 6/22; Y10S 903/903; B60W 2540/10; B60Y 2300/188; B60W 2710/083; B60Y 2200/92; B60Y 2300/18175; B60W 2520/26

(57) ABSTRACT

A method of controlling an engine driving force during operation of a traction control system (TCS) of a hybrid vehicle includes: calculating a driver-demanded torque based on a detection signal of an accelerator position sensor (APS), determining whether the TCS is operating, and, upon determining that the TCS is operating, determining engine driving force based on a TCS-demanded torque according to operation of the TCS. Accordingly, the engine driving force (i.e., an engine operating point) is determined based on the TCS-demanded torque requested in order to reduce the torque of the hybrid vehicle during the TCS operation, so as to improve fuel efficiency by reducing fuel consumption during the TCS operation.

### CROSS-REFERENCE TO RELATED APPLICATION

This application claims under 35 U.S.C. § 119(a) the benefit of Korean Patent Application No. 10-2016-0105973 filed on Aug. 22, 2016, the entire contents of which are incorporated herein by reference.

### BACKGROUND

### (a) Technical Field

The present disclosure relates to a method of controlling an engine driving force of a traction control system (TCS) of a hybrid vehicle, more particularly, to a method of controlling the engine driving force during operation of the TCS of the hybrid vehicle, which is capable of improving fuel efficiency during TCS operation.

### (b) Description of the Related Art

As is well known in the art, driving modes of a hybrid vehicle include an EV driving mode, in which a motor is driven, and an HEV driving mode, in which an engine and a motor are driven together.

Such a hybrid vehicle is equipped with a traction control system (TCS), which is a safety system for preventing wheel spin and improving driving stability by autonomously controlling the brakes and motor torque when the vehicle starts or accelerates on a snowy road, an icy road, or an uneven road surface.

Thus, when the hybrid vehicle starts or accelerates on a slippery road and wheel slip occurs due to excessive driving force, the TCS requests a hybrid control unit (HCU), which is a high-level controller, to reduce torque, and the HCU performs torque reduction control for stable travel.

That is, based on a TCS-demanded torque requested by the TCS to reduce the torque in the TCS operation, the high-level controller performs torque intervention control, which only reduces motor torque so as to respond rapidly to the request for torque reduction.

For example, when the TCS-demanded torque is transferred to the high-level controller during the TCS operation, the high-level controller performs torque intervention control, which reduces only the motor torque without changing the engine torque.

However, even during the TCS operation, because the engine driving force (i.e., an engine operating point) is determined based on the driver-demanded torque corresponding to the extent to which an accelerator pedal is pressed, which is detected by an accelerator position sensor (APS), irrespective of the TCS-demanded torque, there is a problem in that fuel is unnecessarily wasted.

Specifically, even while the TCS is operated to reduce the traveling torque of the hybrid vehicle, the engine driving force (the engine operating point) is determined based on the driver-demanded torque, which corresponds to the extent to which the accelerator pedal is pressed. Therefore, when the driver-demanded torque is increased sharply (for example, when the extent to which the accelerator pedal is pressed is increased by 100 percent), the engine driving force is unnecessarily increased to an engine full load level, and consequently, the amount of fuel that is supplied to the engine is increased and fuel efficiency is reduced.

The above information disclosed in this Background section is only for enhancement of understanding of the background of the disclosure and therefore it may contain information that does not form the prior art that is already known in this country to a person of ordinary skill in the art.

### SUMMARY

The present disclosure provides a method of controlling engine driving force during TCS operation of a hybrid vehicle, which is capable of reducing the amount of fuel that is consumed during TCS operation, and improving fuel efficiency by determining the engine driving force (the engine operating point) based on a TCS-demanded torque, which is requested in order to reduce the torque of the vehicle during TCS operation.

In one aspect, the present disclosure provides a method of controlling engine driving force during TCS operation of a hybrid vehicle, including: calculating, by a high-level controller, a driver-demanded torque based on a detection signal of an accelerator position sensor (APS); determining, by the high-level controller, whether a TCS is operating, and, upon determining that the TCS is operating, determining, by the high-level controller, engine driving force based on a TCS-demanded torque according to operation of the TCS.

In a preferred embodiment, upon determining that the TCS is operating, the determining of the engine driving force may include selecting, by the high-level controller, a smaller one of the TCS-demanded torque and the driver-demanded torque as a demanded torque for determination of the engine driving force.

In another preferred embodiment, upon determining that the TCS is operating, the determining of the engine driving force may include selecting, by the high-level controller, the TCS-demanded torque from the TCS-demanded torque and the driver-demanded torque as a demanded torque for determination of the engine driving force.

In still another preferred embodiment, the TCS-demanded torque may be smaller than the driver-demanded torque.

In yet another preferred embodiment, the determining of the engine driving force may include comparing, by the high-level controller, the TCS-demanded torque with a first reference value, and, upon determining that the TCS-demanded torque is larger than the first reference value, determining the engine driving force to be a full load level, the full load level being a level set to enable an engine to output a maximum torque.

In still yet another preferred embodiment, the determining of the engine driving force may include comparing the TCS-demanded torque with a first reference value, and, upon determining that the TCS-demanded torque is smaller than the first reference value, determining, by the high-level controller, the engine driving force to be a part load level, the part load level being lower than a full load level.

In a further preferred embodiment, the method may further include, when the engine driving force is determined to be a part load level, transmitting, by the high-level controller, a part load engine torque command to an engine control unit (ECU) so that the ECU controls the engine driving force to be the part load level.

In another further preferred embodiment, the method may further include, when the engine driving force is determined to be a full load level, transmitting a full load engine torque command to the ECU so that the ECU controls the engine driving force to be the full load level.

In still another further preferred embodiment, the method may further include, upon determining that the TCS is not operating, determining the engine driving force based on the driver-demanded torque calculated based on the detection signal of the APS.

In another aspect, a non-transitory computer readable medium containing program instructions executed by a processor includes: program instructions that calculate a driver-demanded torque based on a detection signal of an accelerator position sensor (APS); program instructions that determine whether a traction control system (TCS) is operating; and upon determining that the TCS is operating, program instructions that determine an engine driving force based on a TCS-demanded torque according to operation of the TCS.

Other aspects and preferred embodiments of the disclosure are discussed infra.

### BRIEF DESCRIPTION OF THE DRAWINGS

The above and other features of the present disclosure will now be described in detail with reference to certain exemplary embodiments thereof illustrated in the accompanying drawings which are given hereinbelow by way of illustration only, and thus are not limitative of the present disclosure, and wherein:

FIG. 1 (RELATED ART) is a graph showing a conventional process of controlling engine driving force during TCS operation;

FIG. 2 (RELATED ART) is a flowchart showing a conventional method of controlling engine driving force during TCS operation;

FIG. 3 is a schematic view of a system of controlling engine driving force during TCS operation according to the present disclosure;

FIG. 4 is a graph showing a process of controlling engine driving force during TCS operation according to the present disclosure; and

FIG. 5 is a flowchart showing a method of controlling engine driving force during TCS operation according to the present disclosure.

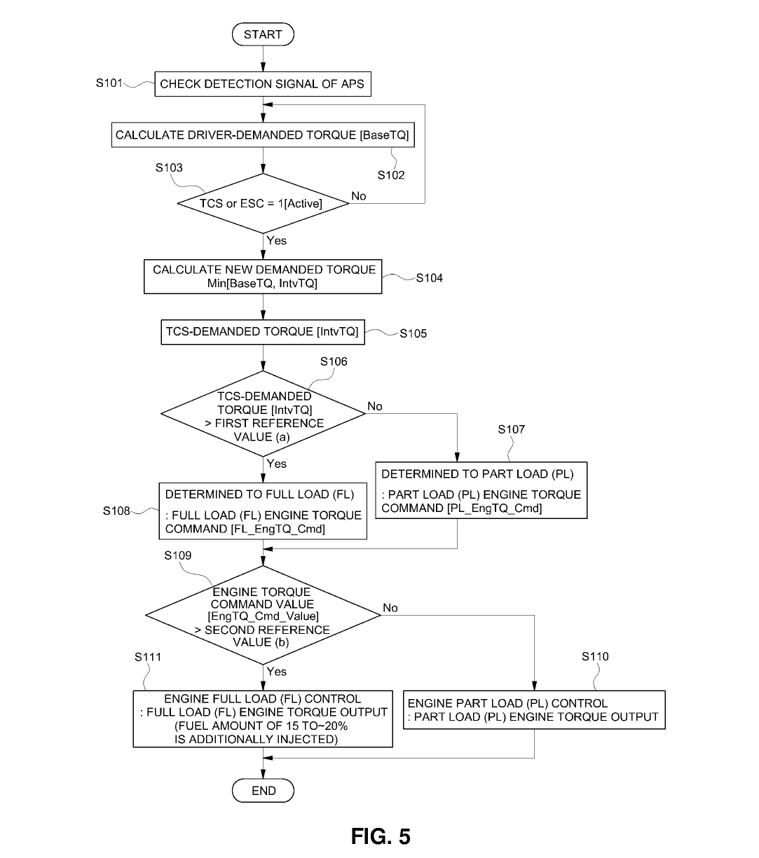

It should be understood that the appended drawings are not necessarily to scale, presenting a somewhat simplified representation of various preferred features illustrative of the basic principles of the disclosure. The specific design features of the present disclosure as disclosed herein, including, for example, specific dimensions, orientations, locations, and shapes, will be determined in part by the particular intended application and use environment.

In the figures, reference numbers refer to the same or equivalent parts of the present disclosure throughout the several figures of the drawing.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Hereinafter reference will now be made in detail to various embodiments of the present disclosure, examples of which are illustrated in the accompanying drawings and described below. While the disclosure will be described in conjunction with exemplary embodiments, it will be understood that the present description is not intended to limit the disclosure to those exemplary embodiments. On the contrary, the disclosure is intended to cover not only the exemplary embodiments, but also various alternatives, modifications, equivalents and other embodiments, which may be included within the spirit and scope of the disclosure as defined by the appended claims.

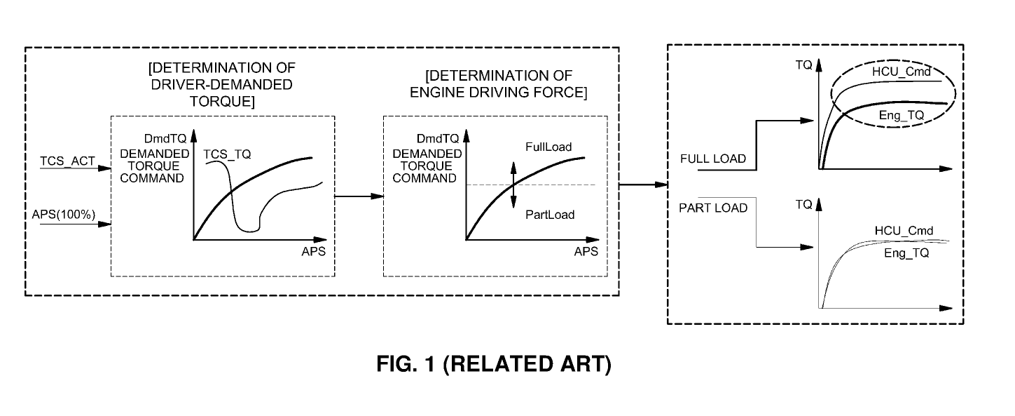

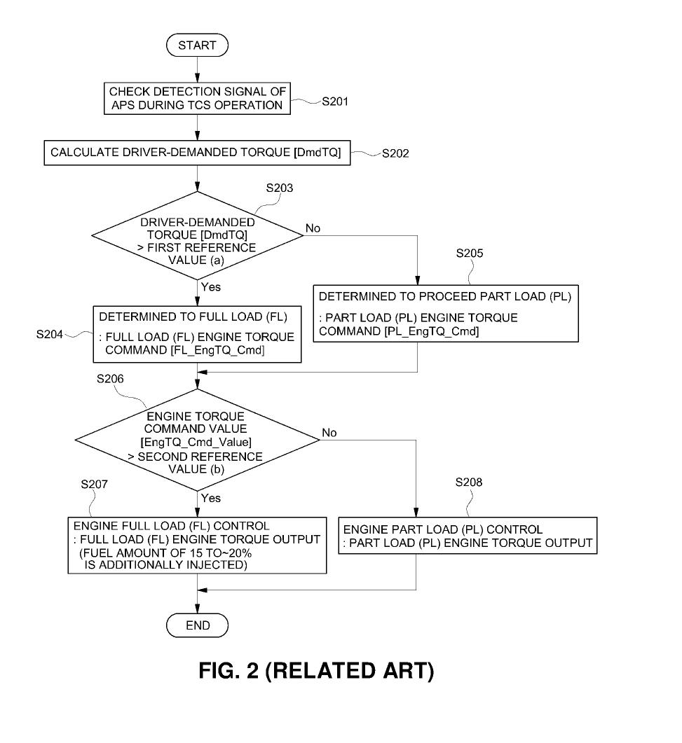

In order to help understand the present disclosure, a conventional process of controlling engine driving force during operation of a traction control system (TCS) will now be explained with reference to FIGS. 1 and 2.

First, a high-level controller checks a detection signal of an accelerator position sensor (APS) during the TCS operation (S201).

Subsequently, the high-level controller calculates a driver-demanded torque DmdTQ based on the detection signal of the APS (S202).

That is, even during the TCS operation, the driver-demanded torque DmdTQ is calculated based on the detection signal of the APS, irrespective of the TCS-demanded torque.

Then, the high-level controller determines engine driving force (an engine operating point) based on the driver-demanded torque (S203).

In particular, the high-level controller compares the driver-demanded torque with a first reference value a. when the driver-demanded torque is larger than the first reference value a, the high-level controller determines the engine driving force to be a full load (FL) level, at which the engine outputs the maximum torque. Conversely, when the driver-demanded torque is smaller than the first reference value a, the high-level controller determines the engine driving force to be a part load (PL) level, which is lower than the FL level.

For reference, the engine driving force (i.e., an engine operating point) of the hybrid vehicle is divided into an optimum driving level, at which the optimum operating point of the engine is realized, a part load level, at which the maximum engine torque is output when the engine is driven under the condition of “engine lambda value (theoretical air-fuel ratio) <1”, and a full load level, at which the maximum possible torque of the engine is output.

After determining the engine driving force to be the full load level, the high-level controller transmits a full load engine torque command FL_EngTQ_Cmd to an engine control unit (ECU) so as to control the engine driving force to be the full load level (S204).

Alternatively, after determining the engine driving force to be the part load level, the high-level controller transmits a part load engine torque command PL_EngTQ_Cmd to the ECU so as to control the engine driving force to be the part load level (S205).

Subsequently, the ECU checks whether the engine torque command value EngTQ_Cmd_Value transmitted from the high-level controller is a full load engine torque command value or a part load engine torque command value (S206).

That is, the ECU compares the engine torque command value EngTQ_Cmd_Value transmitted from the high-level controller with a second reference value b.

When the engine torque command value EngTQ_Cmd_Value is larger than the second reference value b, the ECU performs engine full load control in order to control the engine driving force (the operating point) to be the full load level, and consequently, the torque corresponding to the full load level is output from the engine (S207).

Conversely, when the engine torque command value EngTQ_Cmd_Value is smaller than the second reference value b, the ECU performs engine part load control in order to control the engine driving force (the operating point) to be the part load level, and consequently, the torque corresponding to the part load level is output from the engine (S208).

At this time, the fuel consumption under engine full load control is about 15 to 20 percent higher than under engine part load control.

However, the above-described conventional method of controlling the engine driving force during the TCS operation has the following problems.

Even while the TCS is operated to reduce the traveling torque of the hybrid vehicle, the engine driving force (the engine operating point) is determined based on the driver-demanded torque corresponding to the extent to which the accelerator pedal is pressed. Therefore, when the driver-demanded torque is increased sharply (for example, when the extent to which the accelerator pedal is pressed is increased by 100 percent), the engine driving force is unnecessarily increased to the engine full load level, and consequently, the amount of fuel that is supplied to the engine is increased (for example, fuel is consumed about 15 to 20 percent more than when under engine part load control) and fuel efficiency deteriorates.

Further, there is a large difference between the engine driving force according to the engine torque command value transmitted from the high-level controller during the TCS operation and the actual engine driving force.

For example, as illustrated by the oval-shaped dotted line in FIG. 1, the actual engine torque Eng_TQ does not follow the engine torque commend value HCU_Cmd transmitted from the high-level controller during the engine full load control, and therefore, an error in control of the engine driving force by the high-level controller occurs during the TCS operation.

Hereinafter, a system and a method of controlling the engine driving force during the TCS operation of the hybrid vehicle according to the present disclosure will be described.

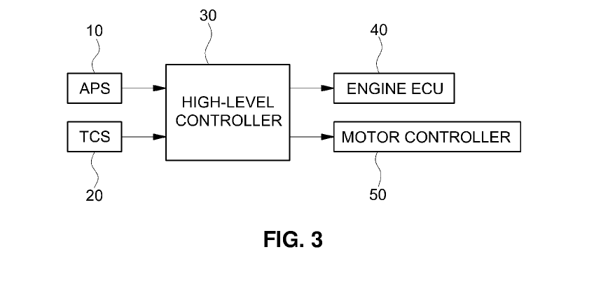

FIG. 3 is a schematic view of a system of controlling the engine driving force during the TCS operation of the hybrid vehicle according to the present disclosure.

Reference numeral 30 in FIG. 3 denotes a high-level controller of the hybrid vehicle.

The high-level controller 30 is the highest-level controller of the hybrid vehicle, which transmits a control command to a variety of electronic components and a variety of control units (an engine control unit (ECU), a motor controller, etc.).

An accelerator position sensor (APS) 10 and a traction control system (TCS) 20 are electrically connected to input terminals of the high-level controller 30 so as to transmit electric signals to the high-level controller 30, and an engine control unit (ECU) 40 and a motor controller 50 are electrically connected to output terminals of the high-level controller 30 so as to receive electric signals from the high-level controller 30.

The TCS is a safety system for preventing wheel spin and improving driving stability by autonomously controlling the brakes and the motor torque when the vehicle starts or accelerates on a snowy road, an icy road, or an uneven road surface. Such a TCS transmits an electric signal indicating whether the TCS is operating to the high-level controller.

The APS detects the extent to which the accelerator pedal is pressed by the driver, and transmits the detection signal to the high-level controller.

The ECU 40 controls the engine driving force (the engine operating point) based on the engine torque command transmitted from the high-level controller 30, and the motor controller 50 controls the motor driving force based on the motor torque command transmitted from the high-level controller 30.

First, the high-level controller checks the detection signal of the APS (S101).

Subsequently, the high-level controller calculates a driver-demanded torque BaseTQ based on the detection signal of the APS (S102).

Then, the high-level controller checks whether the TCS is operating (S103).

For reference, an electronic stability control (ESC) system is a device that controls the orientation of the vehicle body so as to prevent the vehicle from slipping, like the TCS. In the case of a vehicle equipped with such an ESC, the high-level controller may check whether the ESC is operating.

Upon determining that the TCS is operating (TCS=1 [Active]), the high-level controller selects the smaller one of the TCS-demanded torque IntvTQ according to the TCS operation, and the driver-demanded torque BaseTQ (S104).

Here, the driver-demanded torque BaseTQ is the torque of the vehicle that is generated when the driver steps on the accelerator pedal to accelerate the vehicle, and the TCS-demanded torque IntvTQ is the torque that is requested in order to reduce the torque of the vehicle so as to stably brake and drive when the vehicle starts or accelerates on a snowy road, an icy road or an uneven road surface. Thus, the TCS-demanded torque IntvTQ is smaller than the driver-demanded torque BaseTQ.

Therefore, upon determining that the TCS is operating (TCS=1 [Active]), the high-level controller selects the TCS-demanded torque IntvTQ, rather than the driver-demanded torque, as a demanded torque for determination of the engine driving force (the operating point) (S105).

Conversely, upon determining that the TCS is not operating, the high-level controller determines the engine driving force based on the driver-demanded torque BaseTQ, which was calculated in step S102.

Subsequently, the high-level controller determines the engine driving force (the engine operating point) based on the TCS-demanded torque IntvTQ (S106).

In particular, the high-level controller compares the TCS-demanded torque IntvTQ with a first reference value a. When the TCS-demanded torque IntvTQ is larger than the first reference value a, the high-level controller determines the engine driving force to be a full load (FL) level, at which the engine outputs the maximum torque. Conversely, when the TCS-demanded torque IntvTQ is smaller than the first reference value a, the high-level controller determines the engine driving force to be a part load (PL) level, which is lower than the FL level.

As described above, because the TCS-demanded torque IntvTQ is smaller than the driver-demanded torque BaseTQ, the case in which the TCS-demanded torque IntvTQ exceeds the first reference value a hardly occurs in comparison with the case in which the driver-demanded torque BaseTQ exceeds the first reference value a (in the related art, the driver-demanded torque BaseTQ is compared with the first reference value a). Accordingly, the engine driving force may be set to the part load level, which is lower than the full load level.

Therefore, after determining that the engine driving force is to be set to the part load level, the high-level controller transmits a part load engine torque command PL_EngTQ_Cmd to the ECU so as to control the engine driving force to be the part load level (S107).

Upon determining that the TCS-demanded torque IntvTQ is larger than the first reference value a, the high-level controller determines the engine driving force to be the full load level and transmits a full load engine torque command FL_EngTQ_Cmd to the ECU so as to control the engine driving force to be the full load level (S108).

Subsequently, the ECU checks whether the engine torque command value EngTQ_Cmd_Value, transmitted from the high-level controller, is a full load engine torque command value or a part load engine torque command value (S109).

That is, the ECU compares the engine torque command value EngTQ_Cmd_Value, transmitted from the high-level controller, with a second reference value b.

When the engine torque command value EngTQ_Cmd_Value is smaller than the second reference value b, the ECU performs engine part load control in order to control the engine driving force (the operating point) to be the part load level, and consequently, the torque corresponding to the part load level is output from the engine (S110).

Conversely, when the engine torque command value EngTQ_Cmd_Value is larger than the second reference value b, the ECU performs engine full load control in order to control the engine driving force (the operating point) to be the full load level, and consequently, the torque corresponding to the full load level is output from the engine (S111).

As described above, since the engine driving force is determined based on the TCS-demanded torque IntvTQ instead of the driver-demanded torque, during the TCS operation, it is possible to minimize or avoid the situation where the engine driving force is determined to be the full load level and it is possible to set the engine driving force to the part load level, which is lower than the full load level, thereby reducing the amount of fuel that is supplied to the engine and improving fuel efficiency.

Further, the difference between the engine driving force according to the engine torque command value transmitted from the high-level controller during the TCS operation and the actual engine driving force may be reduced.

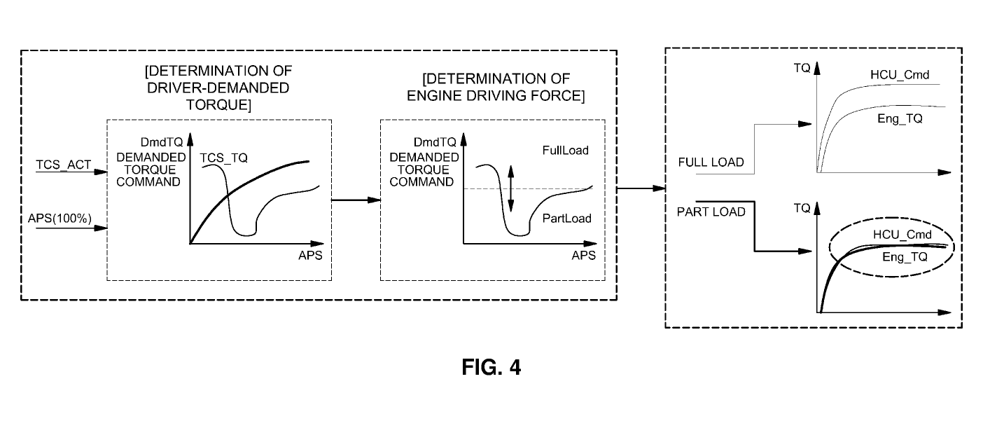

For example, as illustrated by the oval-shaped dotted line in FIG. 4, the actual engine torque Eng_TQ follows the engine torque commend value HCU_Cmd transmitted from the high-level controller during the engine part load control, whereby it is possible to solve the problem in which an error occurs when controlling the engine driving force using the high-level controller during the TCS operation.

As is apparent from the above description, the present disclosure provides a method of controlling engine driving force during TCS operation of a hybrid vehicle, in which the engine driving force (the engine operating point) is determined based on a TCS-demanded torque requested in order to reduce the torque of the vehicle during the TCS operation, thereby realizing the reduction of the engine driving force during the TCS operation and improving fuel efficiency by reducing fuel consumption due to an unnecessary increase in the engine driving force during the TCS operation.

The disclosure has been described in detail with reference to preferred embodiments thereof. However, it will be appreciated by those skilled in the art that changes may be made in these embodiments without departing from the principles and spirit of the disclosure, the scope of which is defined in the appended claims and their equivalents.

What is claimed is:

1. A method of controlling an engine driving force during operation of a traction control system (TCS) of a hybrid vehicle, comprising:
calculating, by a high-level controller, a driver-demanded torque based on a detection signal of an accelerator position sensor (APS);
determining, by the high-level controller, whether the TCS is operating; and
upon determining that the TCS is operating, determining, by the high-level controller, the engine driving force based on a TCS-demanded torque according to operation of the TCS.

2. The method of claim 1, wherein, upon determining that the TCS is operating, the determining of the engine driving force includes selecting, by the high-level controller, a smaller one of the TCS-demanded torque and the driver-demanded torque as a demanded torque for determination of the engine driving force.

3. The method of claim 1, wherein, upon determining that the TCS is operating, the determining of the engine driving force includes selecting, by the high-level controller, the TCS-demanded torque out of the TCS-demanded torque and the driver-demanded torque as a demanded torque for determination of the engine driving force.

4. The method of claim 3, wherein the TCS-demanded torque is smaller than the driver-demanded torque.

5. The method of claim 1, wherein the determining of the engine driving force includes comparing, by the high-level controller, the TCS-demanded torque with a first reference value, and, upon determining that the TCS-demanded torque is larger than the first reference value, determining, by the high-level controller, the engine driving force to be a full load level, the full load level being a level at which an engine outputs a maximum torque.

6. The method of claim 1, wherein the determining of the engine driving force includes comparing, by the high-level controller, the TCS-demanded torque with a first reference value, and, upon determining that the TCS-demanded torque is smaller than the first reference value, determining, by the high-level controller, the engine driving force to be a part load level, the part load level being lower than a full load level.

7. The method of claim 1, further comprising:
when the engine driving force is determined to be a part load level, transmitting, by the high-level controller, a part load engine torque command to an engine control unit (ECU) so that the ECU controls the engine driving force to be the part load level.

8. The method of claim 1, further comprising:
when the engine driving force is determined to be a full load level, transmitting a full load engine torque command to the ECU so that the ECU controls the engine driving force to be the full load level.

9. The method of claim 1, further comprising:
upon determining that the TCS is not operating, determining the engine driving force based on the driver-demanded torque calculated based on the detection signal of the APS.

10. A non-transitory computer readable medium containing program instructions executed by a processor, the computer readable medium comprising:
program instructions that calculate a driver-demanded torque based on a detection signal of an accelerator position sensor (APS);
program instructions that determine whether a traction control system (TCS) is operating; and
upon determining that the TCS is operating, program instructions that determine an engine driving force based on a TCS-demanded torque according to operation of the TCS.
